(19) United States
(12) Patent Application Publication
(10) Pub. No.: US 2019/0120145 A1
(43) Pub. Date: Apr. 25, 2019

(54) GAS TURBINE HAVING FUEL GAS MONITORING SYSTEM

(71) Applicant: SIEMENS ENERGY, INC., Orlando, FL (US)

(72) Inventors: Richard H. Bunce, Glen Mills, PA (US); Damien G. Teehan, St. Cloud, FL (US)

(21) Appl. No.: 16/094,484

(22) PCT Filed: May 23, 2016
(86) PCT No.: PCT/US2016/033741

§ 371 Date: Oct. 18, 2018

(51) Int. Cl. F02C 9/26; F23N 1/00; F23N 5/26; G01N 21/31; G01N 30/72

(52) U.S. Cl. CPC F02C 9/26; F23N 1/005; F23N 5/265; G01N 21/31; F23N 2041/20; F05D 2270/082; F05D 2270/803; F05D 2270/804; F23N 2027/20; G01N 30/7206

(57) ABSTRACT

A gas turbine and a method for operating a gas turbine having a fuel gas monitoring system are presented. The fuel gas monitoring system may provide a measurement of a parameter of a fuel gas in real time. An operation of a gas turbine may be optimized to adapt variation in hydrocarbon content of a fuel gas from the measurement. The fuel gas monitoring system may provide an optical, flow through, online monitoring of fuel gas composition.

### FIELD OF THE INVENTION

This invention relates generally to a gas turbine and a method for operating a gas turbine having a fuel gas monitoring system.

### DESCRIPTION OF THE RELATED ART

Gas turbine may be one of the power generation apparatus in a power plant. Gas turbine may generate power output from combustion of a fuel gas and air mixture. Operation of a gas turbine may be optimized using a fuel gas with a known energy composition. Fuel gas may be supplied by domestic natural gas.

To supplement domestic natural gas supply, offshore liquefied natural gas may be used as a substitute supply. Composition and hydrocarbon content of offshore liquefied natural gas may be significantly different than that expected from the domestic supply. Variation in fuel gas energy composition may lead to power plants using fuel gas that violates combustion turbine fuel specification of a power plant. The violation may cause operational problems. A turbine control system may need to be adjusted to operate using a different fuel gas supply. Variation in fuel gas energy composition may results in substantial megawatt load swings, engine overfiring, and increased emissions of undesirable pollutants, such as NO_{X} and CO.

### SUMMARY OF THE INVENTION

Briefly described, aspects of the present invention relate to a gas turbine and a method for operating a gas turbine having a fuel gas monitoring system.

According to an aspect, a gas turbine is presented. The gas turbine comprises a compressor that is configured to compress air. The gas turbine comprises a combustor located downstream of the compressor that is configured to receive the compressed air. The gas turbine comprises a fuel gas supply line connected to the combustor that is configured to supply fuel gas to the combustor. The fuel gas and the compressed air may be mixed and combusted in the combustor to generate working gas. The gas turbine comprises a turbine located downstream of the combustor that is configured to expand the working gas to generate power output. The gas turbine comprises a fuel gas monitoring system that is configured to provide a measurement of a parameter of the fuel gas in real time. The fuel gas monitoring system comprises an inlet and an outlet. A fuel gas sample may flow into the fuel gas monitoring system through the inlet. The fuel gas sample may be discharged from the fuel gas monitoring system through the outlet. The gas turbine comprises a control system that is configured to adjust an operating parameter of the gas turbine based on the measurement of the parameter of the fuel gas.

According to an aspect, a method for operating a gas turbine is presented. The method comprises compressing air by a compressor. The method comprises receiving the compressed air by a combustor located downstream of the compressor. The method comprises supplying fuel gas to the combustor by a fuel gas supply line. The method comprises mixing the fuel gas with the compressed air and combusting the mixture in the combustor to generate working gas. The method comprises expanding the working gas in a turbine located downstream of the combustor to generate power output. The method comprises measuring a parameter of the fuel gas by a fuel gas monitoring system. The fuel gas monitoring system comprises an inlet and an outlet. A fuel gas sample may flow into the fuel gas monitoring system through the inlet. The fuel gas sample may be discharged from the fuel gas monitoring system through the outlet. The fuel gas monitoring system is configured to provide a measurement of a parameter of the fuel gas in real time. The method comprises adjusting an operating parameter of the gas turbine based on the measurement of the parameter of the fuel gas by a control system.

Various aspects and embodiments of the application as described above and hereinafter may not only be used in the combinations explicitly described, but also in other combinations. Modifications will occur to the skilled person upon reading and understanding of the description.

### BRIEF DESCRIPTION OF THE DRAWINGS

Exemplary embodiments of the application are explained in further detail with respect to the accompanying drawings. In the drawings:

FIG. 1 illustrates a schematic diagram of a gas turbine having a fuel gas monitoring system according to an embodiment;

FIG. 2 illustrates a schematic diagram of a fuel gas monitoring system according to an embodiment;

FIG. 3 illustrates a schematic diagram of a gas turbine having a fuel gas monitoring system according to an embodiment, wherein the fuel gas monitoring system comprises an upstream and a downstream pressure regulating devices;

FIG. 4 illustrates a schematic diagram of a gas turbine having a fuel gas monitoring system according to an embodiment, wherein the fuel gas monitoring system comprises a blower;

FIG. 5 illustrates a schematic diagram of a gas turbine having a fuel gas monitoring system according to an embodiment, wherein the fuel gas monitoring system comprises an enclosure enclosing a vicinity area around the fuel gas monitoring system;

FIG. 6 illustrates a schematic diagram of a gas turbine having a fuel gas monitoring system according to an embodiment, wherein a fuel gas sample discharged from the fuel gas monitoring system may be ignited within an enclosure; and

FIG. 7 illustrates a schematic diagram of a gas turbine having an integrated fuel gas monitoring system according to an embodiment, wherein a fuel gas sample discharged from the fuel gas monitoring system may be removed from a hazardous area.

To facilitate understanding, identical reference numerals have been used, where possible, to designate identical elements that are common to the figures.

### DETAILED DESCRIPTION OF INVENTION

A detailed description related to aspects of the present invention is described hereafter with respect to the accompanying figures.

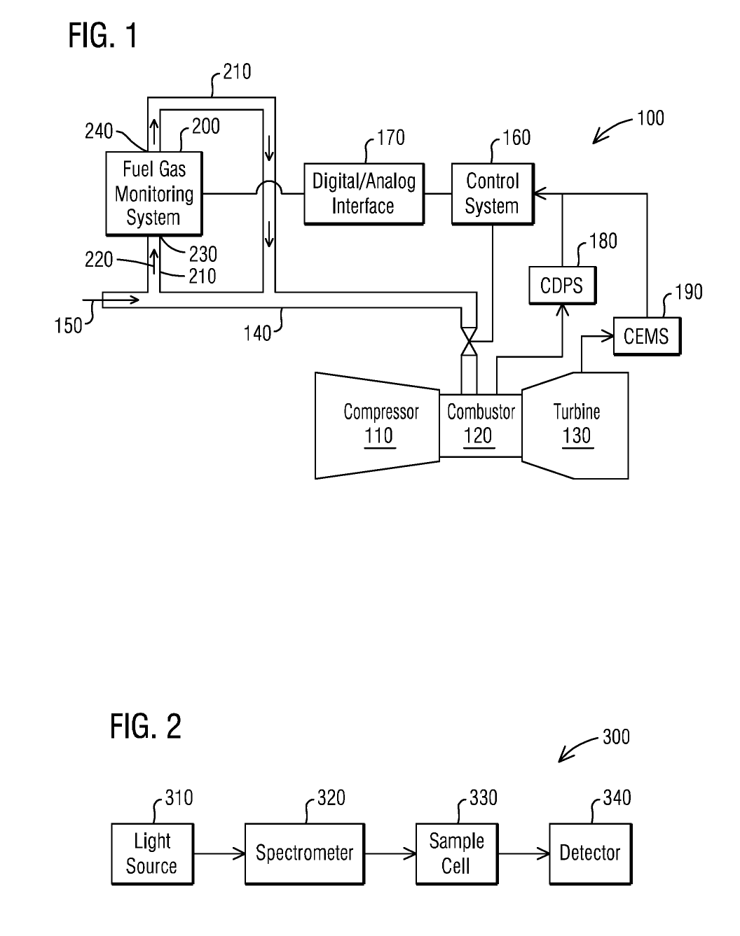

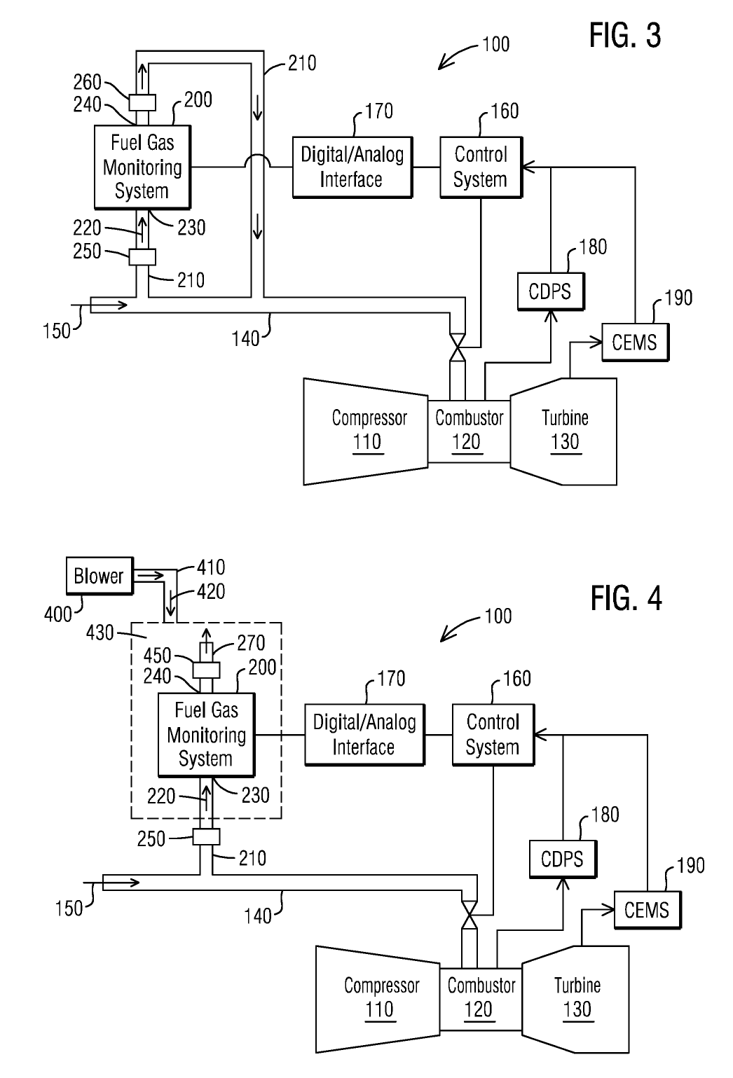

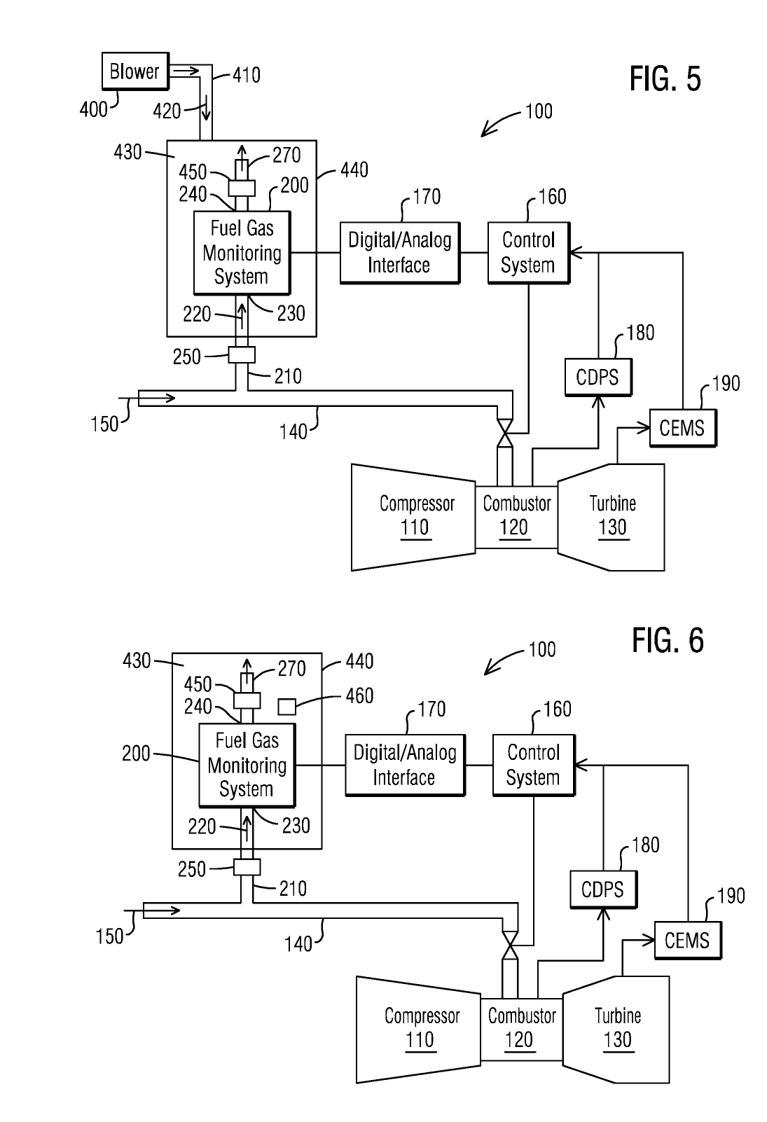

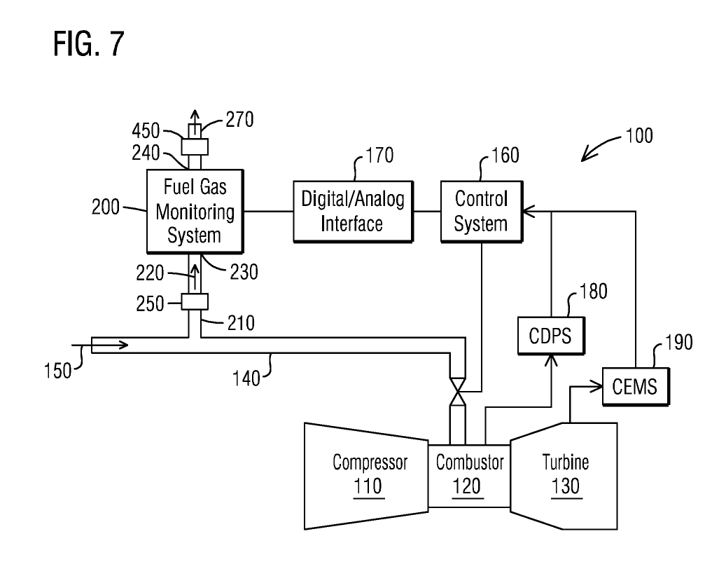

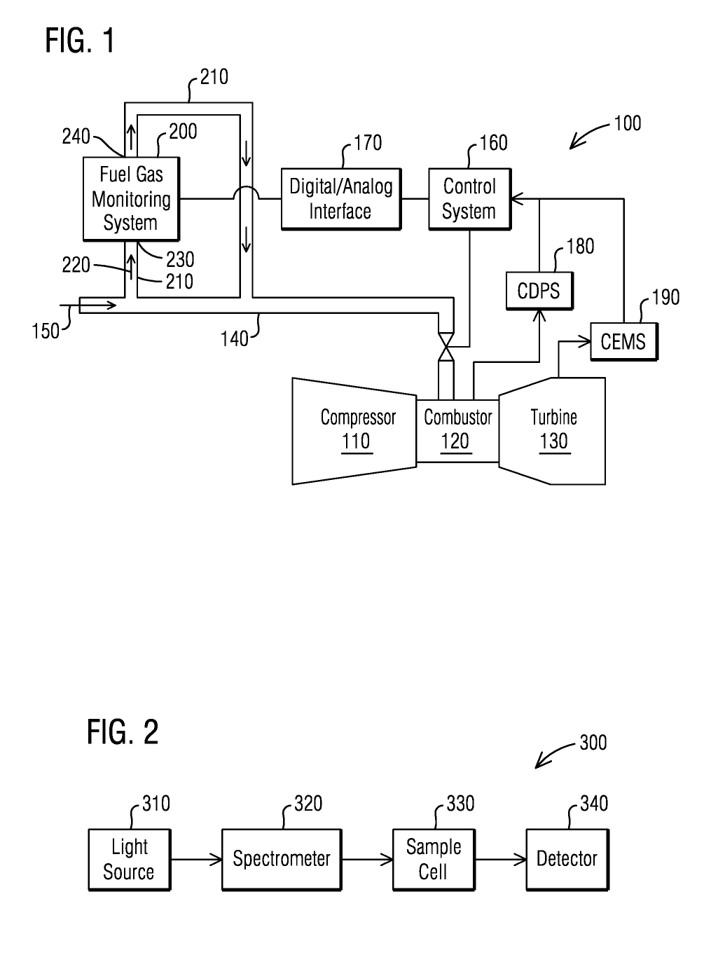

FIG. 1 illustrates a schematic diagram of a gas turbine 100 according to an embodiment. As illustrated in the exemplary embodiment of FIG. 1, the gas turbine 100 may includes a compressor 110. The compressor 110 may be configured to compress air entering into the compressor 110. The gas turbine 100 may include a combustor 120. The combustor 120 may be arranged downstream of the compressor 110 to receive the compressed air. The gas turbine 100 may include a fuel gas supply line 140. The fuel gas supply line 140 may be connected to the combustor 120. The fuel gas supply line 140 may be configured to supply fuel gas 150 to the combustor 120. The fuel gas 150 and the compressed air from a compressor 110 may be mixed and combusted in the combustor 120 to generate working gas. The gas turbine 100 may include a turbine 130. The turbine 130 may be arranged downstream of the combustor 120. The turbine 130 may be configured to expand the working gas to generate power output.

A gas turbine 100 may include a fuel gas monitoring system 200. The fuel gas monitoring system 200 may be configured to measure a parameter of a fuel gas 150 entering into the combustor 120 in real time. According to an embodiment, a parameter of a fuel gas 150 may include analysis of hydrocarbon content in the fuel gas 150. Variation in hydrocarbon content in a fuel gas 150 may result in variation of a heating value of the fuel gas 150. A heating value of a fuel gas 150 may be defined by a Wobbe Index. According to an embodiment, an operation parameter of a gas turbine 100 may need to be adjusted to adapt variation of a heating value of a fuel gas 150 for an optimal operation.

A gas turbine 100 may include a control system 160. The control system 160 may be configured to adjust an operating parameter of the gas turbine 100 based on a measurement of a parameter of the fuel gas 150. According to an embodiment, an operating parameter of a gas turbine 100 may include megawatt controller parameter, exhaust gas temperature controller parameter, blade path temperature controller parameter, ignition fuel mass flow setpoint value, pilot valve ignition lift, fuel gas distribution among combustion stages, combustor fuel stage throttle valve ignition lifts, etc.

A gas turbine 100 may include an interface 170. The interface 170 may be arranged between a fuel gas monitoring system 200 and a control system 160. The interface 170 may be configured to convert measurement of a parameter of the fuel gas 150 from a digital signal to an analog signal, or from an analog signal to a digital signal.

A gas turbine 100 may include a combustion dynamics protection system (CDPS) 180. The CDPS 180 may be connected to the combustor 120. The CDPS 180 may be configured to monitor potentially destructive combustion dynamics in the combustor 120. The measurement data from the CDPS 180 may be fed to the control system 160.

A gas turbine 100 may include a continuous emission monitoring system (CEMS) 190. The CEMS 190 may be arranged downstream of a turbine 130. The CEMS 190 may be configured to monitor amount of pollutants in an exhaust gas of the turbine 130, for exemplary, an amount of NO_{X} and CO in an exhaust gas of the turbine 130. The measurement data from the CEMS 190 may be fed to the control system 160. A control system 160 may be configured to adjust an operating parameter of the gas turbine 100 based on a measurement of a parameter of the fuel gas 150 taking into account of measurement data from the CDPS 180 as well as from the CEMS 190.

A fuel gas monitoring system 200 may include an inlet 230 and an outlet 240. A fuel gas sample line 210 may be arranged between the fuel gas monitoring system 200 and the fuel gas supply line 140. A fuel gas sample 220 may flow into the fuel gas monitoring system 200 through the inlet 230 via the fuel gas sample line 210. The fuel gas sample 220 may be discharged from the monitoring system 200 through the outlet 240. The fuel gas sample 220 may be discharged from the monitoring system 200 into the fuel gas supply line 140 via the fuel gas sample line 210.

According to an embodiment, a fuel gas monitoring system 200 may include an optical system. An optical system of a fuel gas monitoring system 200 may include a tunable filter spectrometer system 300. FIG. 2 illustrates a schematic diagram of a tunable filter spectrometer system 300 according to an embodiment. According to the illustrated exemplary embodiment of FIG. 2, a tunable filter spectrometer system 300 may include a light source 310, a spectrometer 320, a sample cell 330, and a detector 340. The spectrometer 320 may separate wavelength components of a broadband light generated by the light source 310. The components of the light may interact with sample molecules of a sample in the sample cell 330. A sample in the sample cell 330 may include gas, liquids, or solids. According to an embodiment, a sample in the sample cell 330 comprises a fuel gas sample 220. The detector 340 may be configured to analyze a resulting spectrum of the wavelength components after interaction with the sample molecules. The detector 340 may include a photo detector. The resulting spectrum may be used to quantify a composition of the fuel gas sample 220.

According to an embodiment, a fuel gas monitoring system 200 may include a Wobbe Index Meter incorporated with a gas chromatograph. A Wobbe Index Meter incorporated with a gas chromatograph may provide a measurement of fuel gas composition in a time period of at least 5 minutes or more. A buffer tank may be required to provide a delay period sufficient for a control system 160 to adjust an operation parameter of a gas turbine 100 based on the measurement of fuel gas composition. A Wobbe Index Meter incorporated with a gas chromatograph may require a constant supply of a carrier gas for gas chromatograph analysis. A Wobbe Index Meter incorporated with a gas chromatograph may require calibration gas for periodic calibration.

According to an embodiment, a fuel gas monitoring system 200 using a tunable filter spectrometer system 300 may provide an optical flow through online monitoring of a composition of fuel gas 150. A fuel gas monitoring system 200 using a tunable filter spectrometer system 300 may provide a measurement of a parameter of fuel gas 150 in real time, for exemplary, within 5 minutes, or within 2 minutes, or within 1 minute, or within 10 seconds, or within 5 seconds, or within 1 second. A parameter of fuel gas 150 may include fuel gas energy. A fuel gas monitoring system 200 using a tunable filter spectrometer system 300 may reduce a size of a buffer tank that may be required using a Wobbe Index Meter incorporated with a gas chromatograph. A fuel gas monitoring system 200 using a tunable filter spectrometer system 300 may eliminate a buffer tank. A fuel gas monitoring system 200 using a tunable filter spectrometer system 300 may eliminate a need of a carrier gas. A fuel gas monitoring system 200 using a tunable filter spectrometer system 300 may eliminate a need of calibration.

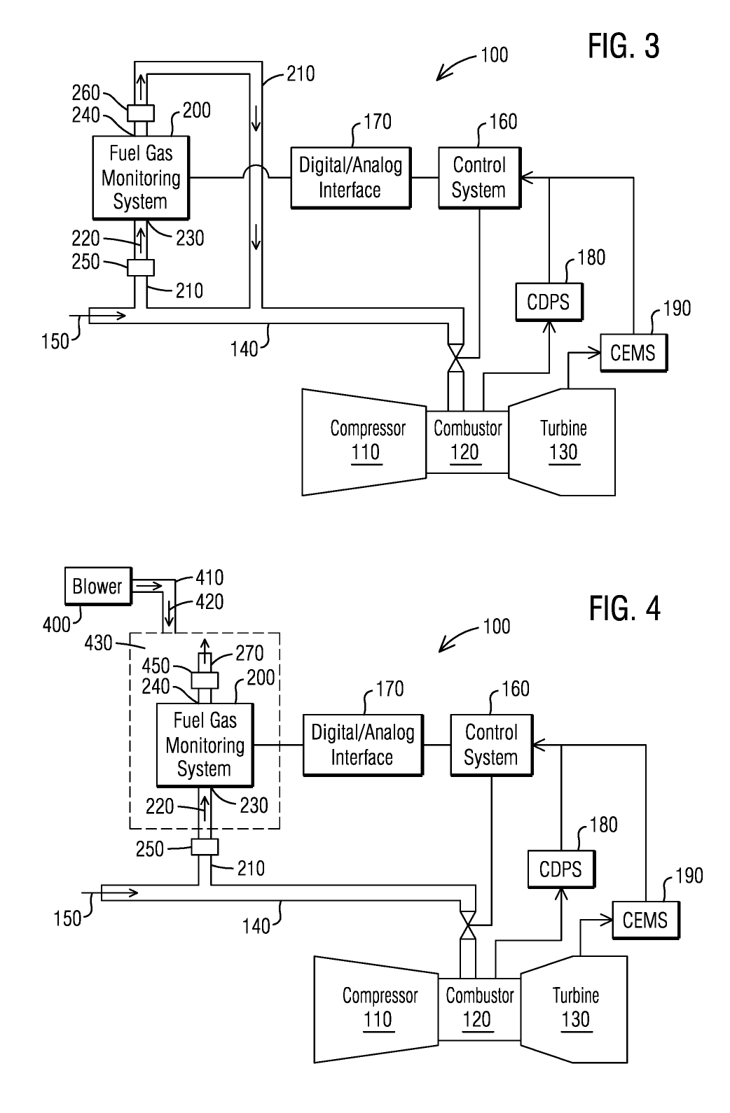

FIG. 3 illustrates a schematic diagram of a gas turbine 100 according to an embodiment. According to an embodiment, an operating pressure of a fuel gas monitoring system 200 may be different from a pressure of a fuel gas 150. As illustrated in the embodiment of FIG. 3, an upstream pressure regulating device 250 may be arranged upstream of an inlet 230 of the fuel gas monitoring system 200. The upstream pressure regulating device 250 may be configured to regulate a pressure of a fuel gas sample 220 flowing into the fuel gas monitoring system 200 to an operating pressure of the fuel gas monitoring system 200. A downstream pressure regulating device 260 may be arranged downstream of an outlet 240 of the fuel gas monitoring system 200. The downstream pressure regulating device 260 may be configured to regulate a pressure of the fuel gas sample 220 discharged from the fuel gas monitoring system 200 to a pressure of the fuel gas 150. The fuel gas sample 220 may be discharged from the fuel gas monitoring system 200 back into a fuel gas supply line 140. According to an embodiment, an upstream pressure regulating device 250 and a downstream pressure regulating device 260 may include a pressure control valve, an orifice, a nozzle, an expander, a converge, a diverge, etc.

A gas turbine 100 may be operated in a hazardous area. The National Electrical Code (NEC) defines a hazardous area as the following: “An area where a potential hazard (e.g., a fire, an explosion, etc.) may exist under normal or abnormal conditions because of the presence of flammable gases or vapors, combustible dusts or ignitable fibers or flyings.” According to an embodiment, a gas turbine 100 may be operated in an area with a Class 1 Division 2 Group D rating per NEC. A fuel gas monitoring system 200 should be in compliance with safety precaution regulations at an operation area of the gas turbine 100.

FIG. 4 illustrates a schematic diagram of a gas turbine 100 according to an embodiment. According to the illustrated exemplary embodiment of FIG. 4, a blower 400 may be mounted at an area outside a hazardous area of an operation area of a gas turbine 100. The blower 400 may be mounted at an area outside NEC Class 1 Division 2. A pipe 410 may be connected to the blower 400. The pipe 410 may extend from the blower 400 to a vicinity area 430 around a fuel gas monitoring system 200. The blower 400 may blow a non-combustible medium 420 to the vicinity area 430 through the pipe 410. According to an embodiment, the non-combustible medium 420 may include flow of air or inert gas. The non-combustible medium 420 may purge the vicinity area 430 around the fuel gas monitoring system 200. A fuel gas sample 220 discharged from the fuel gas monitoring system 200 may be diluted by the non-combustible medium 420 to become non-combustible. The diluted fuel gas sample 220 discharged from the fuel gas monitoring system 200 may vent out via a venting pipe 270.

A sensor 450 may be arranged downstream of an outlet 240 of a fuel gas monitoring system 200. The sensor 450 may be configured to monitor a property of a fuel gas sample 220 discharged from the fuel gas monitoring system 200 prior to venting out.

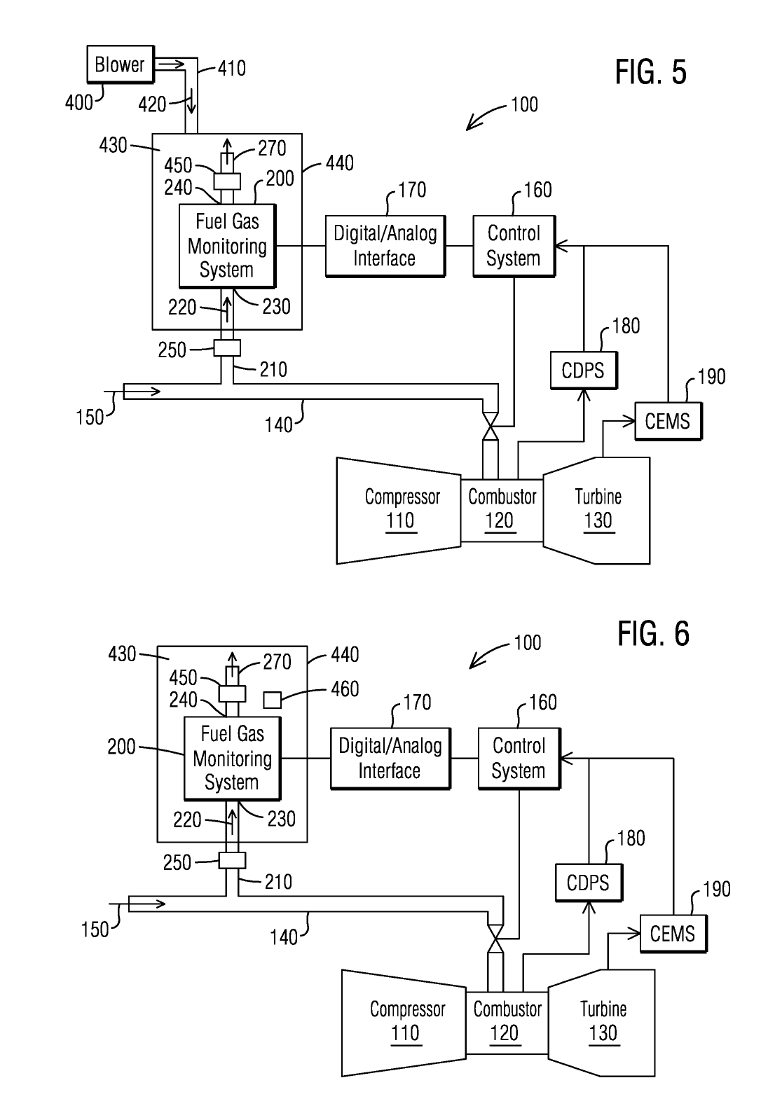

FIG. 5 illustrates a schematic diagram of a gas turbine 100 according to an embodiment. According to the illustrated exemplary embodiment of FIG. 5, an enclosure 440 may be arranged to enclose a vicinity area 430 around a fuel gas monitoring system 200. The enclosure 440 may be designed to meet a safety precaution regulation at an operation area of a gas turbine 100. A blower 400 may be mounted at an area outside a hazardous area of an operation area of a gas turbine 100. A pipe 410 may be connected to the blower 400. The pipe 410 may extend from the blower 400 to the enclosure 440. The blower 400 may blow a non-combustible medium 420 to the enclosure 440 enclosing the vicinity area 430. According to an embodiment, the non-combustible medium 420 may include flow of air or inert gas. The non-combustible medium 420 may purge the vicinity area 430 around the fuel gas monitoring system 200 within the enclosure 440. A fuel gas sample 220 discharged from the fuel gas monitoring system 200 may be diluted by the non-combustible medium 420 to become non-combustible. The diluted fuel gas sample 220 discharged from the fuel gas monitoring system 200 may vent out via a venting pipe 270. A sensor 450 may be arranged downstream of an outlet 240 of a fuel gas monitoring system 200. The sensor 450 may be configured to monitor a property of the fuel gas sample 220 discharged from the fuel gas monitoring system 200 prior to venting out.

FIG. 6 illustrates a schematic diagram of a gas turbine 100 according to an embodiment. According to the illustrated exemplary embodiment of FIG. 6, an enclosure 440 may be arranged to enclose a vicinity area 430 around a fuel gas monitoring system 200. An igniter 460 may be arranged inside the enclosure 440. According to an embodiment, the igniter 460 may include an electrical spark or a hot surface. A fuel gas sample 220 discharged from a fuel gas monitoring system 200 may be ignited by the igniter 460. An explosion of the fuel gas sample 220 discharged from a fuel gas monitoring system 200 may be confined within the enclosure 440. According to an embodiment, the enclosure 440 may be designed to meet an explosive-proof requirement. A sensor 450 may be arranged downstream of an outlet 240 of a fuel gas monitoring system 200. The sensor 450 may be configured to monitor a property of the fuel gas sample 220 discharged from the fuel gas monitoring system 200 prior to venting out via a venting pipe 270.

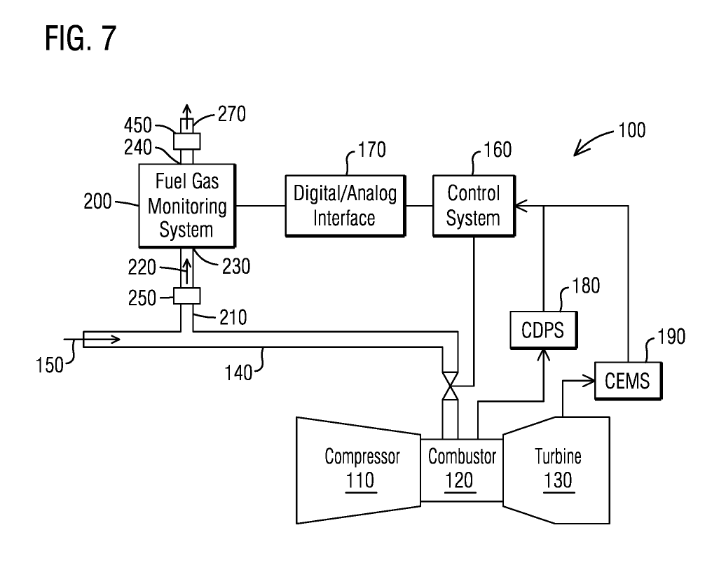

FIG. 7 illustrates a schematic diagram of a gas turbine 100 according to an embodiment. According to the illustrated exemplary embodiment of FIG. 7, a fuel gas sample 220 discharged from a fuel gas monitoring system 200 may be removed from a hazardous area of an operation area of a gas turbine 100 to a safety area via a venting pipe 270. The fuel gas sample 220 discharged from a fuel gas monitoring system 200 may vent out into the safety area. A sensor 450 may be arranged downstream of an outlet 240 of a fuel gas monitoring system 200. The sensor 450 may be configured to monitor a property of the fuel gas sample 220 discharged from the fuel gas monitoring system 200 prior to venting out.

According to an aspect, the illustrated embodiments disclose a gas turbine 100 and a method for operating the gas turbine 100. The gas turbine 100 comprises a fuel gas monitoring system 200. The fuel gas monitoring system 200 may provide a measurement of a parameter of fuel gas 150 in real time. The disclosed fuel gas monitoring system 200 may include an optical system. According to an aspect, the disclosed optical fuel gas monitoring system 200 may provide an optical flow though online monitoring of composition of fuel gas 150. An operation of the proposed gas turbine 100 may be optimized to adapt variation of a heating value of a fuel gas 150. According to an aspect, the fuel gas 150 may include offshore liquefied natural gas.

According to an aspect, the disclosed fuel gas monitoring system 200 may significantly reduce a size of a buffer tank or eliminate a buffer tank. According to an aspect, the disclosed fuel gas monitoring system 200 may eliminate a carrier gas. According to an aspect, the disclosed fuel gas monitoring system 200 may eliminate calibration gas.

According to an aspect, the disclosed fuel gas monitoring system 200 may have a small compact size. The disclosed fuel gas monitoring system 200 may require less installation space. The disclosed fuel gas monitoring system 200 may be installed at a location that is optimal for overall plant layout. The proposed fuel gas monitoring system 200 may require less maintenance cost.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

### LIST OF REFERENCES

100 Gas Turbine
110 Compressor
120 Combustor
130 Turbine
140 Fuel Gas Supply Line
150 Fuel Gas
160 Control System
170 Digital/Analog Interface
180 Combustion Dynamics Protection System (CDPS)
190 Continuous Emission Monitoring System (CEMS)
200 Fuel Gas Monitoring System
210 Fuel Gas Sample Line
220 Fuel Gas Sample
230 Inlet of Fuel Gas Monitoring System
240 Outlet of Fuel Gas Monitoring System
250 Upstream Pressure Regulating Device
260 Downstream Pressure Regulating Device
270 Venting Pipe
300 Tunable Filter Spectrometer System
310 Light Source
320 Spectrometer
330 Sample Cell
340 Detector
400 Blower
410 Pipe
420 Non-combustible Medium
430 Vicinity Area around the Fuel Gas Monitoring System
440 Enclosure
450 Sensor
460 Igniter

1. A gas turbine comprising:
a compressor that is configured to compress air;
a combustor located downstream of the compressor that is configured to receive the compressed air;
a fuel gas supply line connected to the combustor that is configured to supply fuel gas to the combustor, wherein the fuel gas and the compressed air are mixed and combusted in the combustor to generate working gas;
a turbine located downstream of the combustor that is configured to expend the working gas to generate power output;
a fuel gas monitoring system that is configured to provide a measurement of a parameter of the fuel gas in real time, wherein the fuel gas monitoring system comprises an inlet and an outlet, wherein a fuel gas sample flows into the fuel gas monitoring system through the inlet, wherein the fuel gas sample is discharged from the fuel gas monitoring system through the outlet; and
a control system that is configured to adjust an operating parameter of the gas turbine based on the measurement of the parameter of the fuel gas.

2. The gas turbine as claimed in claim 1, wherein the fuel gas monitoring system comprises an optical system.

3. The gas turbine as claimed in claim 1, wherein the fuel gas monitoring system is configured to provide an online measurement of the parameter of the fuel gas.

4. The gas turbine as claimed in claim 1, wherein the fuel gas sample is discharged from the fuel gas monitoring system into the fuel gas supply line.

5. The gas turbine as claimed in claim 1, further comprising an upstream pressure regulating device arranged upstream of the inlet of the fuel gas monitoring system, wherein the upstream pressure regulating device is configured to regulate a pressure of the fuel gas sample flowing into the fuel gas monitoring system to an operating pressure of the fuel gas monitoring system.

6. The gas turbine as claimed in claim 5, further comprising a downstream pressure regulating device arranged downstream of the outlet of the fuel gas monitoring system, wherein the downstream pressure regulating device is configured to regulate a pressure of the fuel gas sample discharged from the fuel gas monitoring system to a pressure of the fuel gas.

7. The gas turbine as claimed in claim 1, further comprising a device that is configured to purge a vicinity area around the fuel gas monitoring system to dilute the fuel gas sample discharged from the fuel gas monitoring system to become non-combustible.

8. The gas turbine as claimed in claim 7, further comprising a sensor (450) that is configured to monitor the fuel gas sample discharged into the vicinity area around the fuel gas monitoring system.

9. The gas turbine as claimed in claim 1, further comprising an enclosure that encloses a vicinity area around the fuel gas monitoring system.

10. The gas turbine as claimed in claim 1, wherein the fuel gas sample is discharged from the fuel gas monitoring system to a safety area.

11. The gas turbine as claimed in claim 1, further comprising an interface arranged between the fuel gas monitoring system and the control system, wherein the interface is configured to convert the measurement of the parameter of the fuel gas between a digital signal and an analog signal.

12. A method for operating a gas turbine comprising:
compressing air by a compressor;
receiving the compressed air by a combustor located downstream of the compressor;
supplying fuel gas to the combustor by a fuel gas supply line;
mixing the fuel gas with the compressed air and combusting the mixture in the combustor to generate working gas;
expanding the working gas in a turbine located downstream of the combustor to generate power output;
providing a measurement of a parameter of the fuel gas in real time by a fuel gas monitoring system, wherein the fuel gas monitoring system comprises an inlet and an outlet, wherein a fuel gas sample flows into the fuel gas monitoring system through the inlet, wherein the fuel gas sample is discharged from the fuel gas monitoring system through the outlet; and
adjusting an operating parameter of the gas turbine based on the measurement of the parameter of the fuel gas by a control system.

13. The method as claimed in claim 12, further comprising providing an online measurement of the parameter of the fuel gas.

14. The method as claimed in claim 12, further comprising discharging the fuel gas sample from the fuel gas monitoring system into the fuel gas supply line.

15. The method as claimed in claim 12, further comprising regulating a pressure of the fuel gas sample flowing into the fuel gas monitoring system to an operating pressure of the fuel gas monitoring system by an upstream pressure regulating device, wherein the upstream pressure regulating device is arranged upstream of the inlet of the fuel gas monitoring system.

16. The method as claimed in claim 15, further comprising regulating a pressure of the fuel gas sample discharged from the fuel gas monitoring system to a pressure of the fuel gas by a downstream pressure regulating device, wherein the downstream pressure regulating device is arranged downstream of the outlet of the fuel gas monitoring system.

17. The method as claimed in claim 12, further comprising purging a vicinity area around the fuel gas monitoring system by a device to dilute the fuel gas sample discharged from the fuel gas monitoring system to become non-combustible.

18. The method as claimed in claim 12, further comprising enclosing a vicinity area around the fuel gas monitoring system by an enclosure.

19. The method as claimed in claim 12, further comprising discharging the fuel gas sample to a safety area.

20. The method as claimed in claim 12, further comprising converting the measurement of the parameter of the fuel gas between a digital signal and an analog signal by an interface.
